(19) United States
(12) Patent Application Publication
(10) Pub. No.: US 2016/0114957 A1
(43) Pub. Date: Apr. 28, 2016

(54) CHARGED PACKAGING MATERIALS

(71) Applicant: SHANGHAI ZHIYI INFORMATION TECHNOLOGY LTD, Shanghai (CN)

(72) Inventor: Bin Ding, Shanghai (CN)

(21) Appl. No.: 14/778,366

(22) PCT Filed: Mar. 21, 2013
(86) PCT No.: PCT/CN2013/073008

§ 371 Date: Sep. 18, 2015

(51) Int. Cl. B65D 81/24; A01N 43/16; A23B 7/153; B65D 81/28; B05D 7/04; B65B 25/00; B65D 65/38; A01N 25/10; B05D 7/00

(52) U.S. Cl. CPC B65D 81/24; A01N 25/10; A01N 43/16; A23B 7/153; B05D 7/58; B05D 7/04; B65B 25/001; B65D 65/38; B65D 81/28; A23V 2002/00

(57) ABSTRACT

Charged packaging materials and methods of making and using are provided herein. In some embodiments, the packaging material includes at least two charged layers. In some embodiments, the material includes alternating layers of charged surfaces in which one or more of the layers includes a preservative. In some embodiments, a perishable product can be packaged in a packaging material.

### FIELD

Embodiments herein relate generally to packaging materials, including, methods of packaging a product, and methods of making the packaging.

### BACKGROUND

A wide variety of materials for packaging and storing items, such as food products, pharmaceuticals, and other perishables, exist. Frequently, such materials function, at least in part, by isolating an external environment from the item to be preserved.

### SUMMARY

Some embodiments provided herein include a charged surface and a first layer over the charged surface. The first layer can include a first preservative. In some embodiments, the first preservative includes a first charge that is electrostatically attracted to the charged surface.

Some embodiments provided herein include a method of storing a perishable product. The method can include providing a packaging material that includes a charged surface that is electrostatically attracted to a first layer. In some embodiments, the first layer includes a biological preservative. The method can include placing a perishable product at least partially within the packaging material.

Some embodiments provided herein include a method of making a packaging material. The method can include providing a substrate. In some embodiments, a surface of the substrate includes a first charge. The method can include applying a first preservation material to the surface of the substrate. In some embodiments, the first preservation material includes a second charge that is electrostatically attracted to the first charge, thus forming a first layer of charged preservation material.

Some embodiments provided herein include a composite film. The composite film can include one or more pairs of alternating layers. The alternating layers can include a first layer. In some embodiments, the first layer includes a self-assembled structure. The alternating layers can include a second layer. In some embodiments, the second layer comprises a self-assembled structure. In some embodiments, the first layer is associated with the second layer via an electrostatic attraction.

Some embodiments provided herein include a packaging material. The packaging material can include a first layer. The first layer can include a first preservative. In some embodiments, the first preservative includes a first charge. The packaging material can include a second layer over the first layer. In some embodiments, the second layer includes a second preservative. In some embodiments, the second preservative includes a second charge that is electrostatically attracted to the first charge.

Some embodiments provided herein include a product disposed within a packaging material. In some embodiments, the product disposed within the packaging material includes a product that is disposed within a packaging material. In some embodiments, the packaging material includes a charged surface. In some embodiments, the packaging material includes a first layer over the charged surface. In some embodiments, the first layer includes a first preservative. In some embodiments, the first preservative includes a first charge that is electrostatically attracted to the charged surface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic drawing illustrating a packaging material and a method of making a packaging material.

FIG. 2 is a flow diagram illustrating some embodiments of a method of storing a perishable product.

FIG. 3 is a flow diagram illustrating some embodiments of a method of making a packaging material.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Some embodiments provided herein relate to packaging materials, including, for example, films and containers. In some embodiments, the packaging material includes alternating charged layers, where each of the layers can be at least partially associated with one other via complementary charges between the layers. Thus, some embodiments provided herein include a packaging material that includes a charged surface and a first layer. The first layer can include a preservative and/or a charge that is electrostatically attracted to the charged surface (in some embodiments, the preservative itself is charged, and thus, can form the layer). For example, the charged surface can include a cation and the first layer can include an anion. In some embodiments, the preservative is antibacterial. In some embodiments, the packaging material includes one or more additional layers. An additional layer can include a charge that is electrostatically attracted to the charge of the layer immediately underneath the additional layer. In some embodiments, at least one of the additional layers further includes a preservative. Further embodiments and methods of making and using such embodiments are provided in more detail below.

Some embodiments provided herein relate to a packaging material. The packaging material can include at least a charged surface, upon which various charged layers can be placed. In some embodiments, the packaging material includes a first layer over the charged surface. The first layer can include a first preservative. The first preservative can include a first charge that is electrostatically attracted to the charged surface. This pairing of complementary charges between the charged surface and the first layer allows for a material that can be held together, at least to some extent, via these electrostatic forces, while still providing a location for the addition of preservatives or other additives.

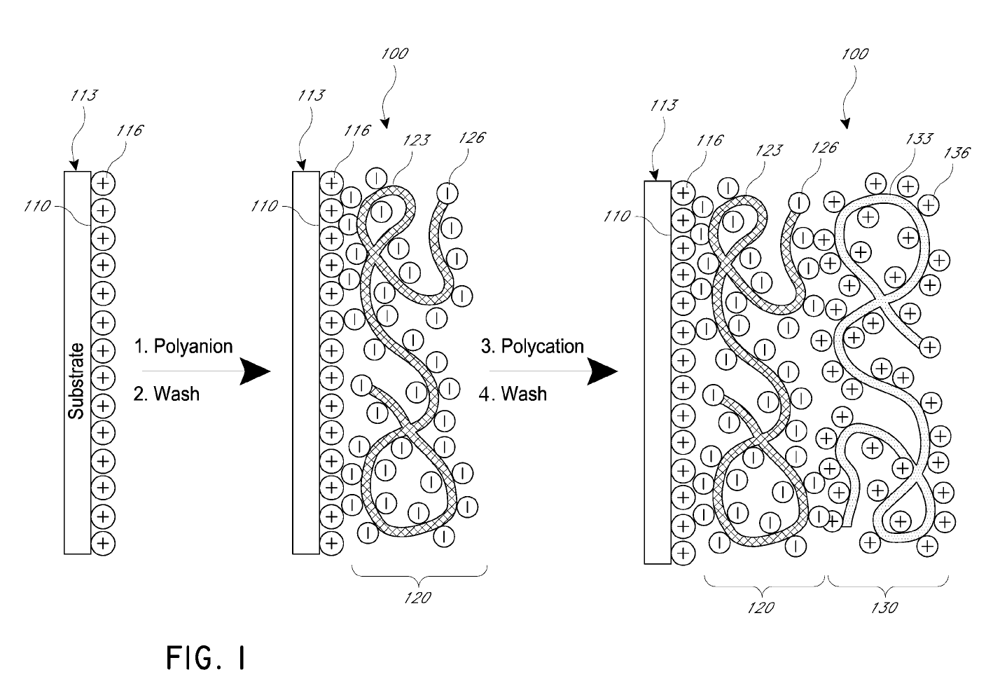

FIG. 1 includes a schematic illustration of a packaging material 100 and an example of how it can be produced. The packaging material 100 can include a charged surface 110. In some embodiments, the charged surface 110 is part of a substrate 113. The charged surface 110 can include one or more charges 116. In some embodiments, the charges can be an inherent aspect of the substrate and/or a surface of the substrate. In some embodiments, the charges and/or charged surface can be added and/or applied to the substrate 113. The packaging material 100 can include a first layer 120 that is adjacent to the charged surface 110. The first layer 120 can include a first preservative 123. The first preservative can include a first charge 126 that is electrostatically attracted to the charged surface 110. In some embodiments, the packaging material 100 also includes a second layer 130 adjacent to the first layer 120. The second layer 130 can include a second preservative 133. The second preservative 133 can include a second charge 136 that is electrostatically attracted to the first charge 126.

In some embodiments, the packaging material includes at least one additional layer over the first layer (for example, the second or further layers), for example at least about 1, 2, 3, 4, 5, 6, 7, 8, 9, 10, 20, 30, 40, 50, 70, 80, 90, or 100 additional layers, including any range between any two of the preceding values and any range above any one of the preceding values. In some embodiments, at least one of the additional layers includes a charge that is electrostatically attracted to the layer beneath it. In some embodiments, at least one of the additional layers includes a preservative. The preservative can be a preservative as described herein. In some embodiments, the packaging material includes a second layer over the first layer. In some embodiments, the second layer includes a second preservative. In some embodiments, the second preservative includes a second charge that is electrostatically attracted to the charge of the first layer (i.e. the first charge). In some embodiments, the packaging material includes a third layer over the second layer. In some embodiments, the third layer includes a third charge that is electrostatically attracted to the second charge. In some embodiments, the packaging material includes a fourth layer over the third layer. In some embodiments, the fourth layer includes a fourth charge that is electrostatically attracted to the third charge. In some embodiments, each layer includes a preservative. In some embodiments, only a fraction of the subsequent layers includes a preservative and/or charge. In some embodiments, at least 0.1% of the layers on the substrate includes a preservative, for example, at least 0.1%, 1%, 2%, 3%, 4%, 5%, 10%, 15%, 20%, 30%, 40%, 50%, 60%, 70%, 80%, 90%, 95%, 96%, 97%, 98%, 99%, or 100% of the layers include a preservative. In some embodiments, charged layers can be employed that lack a preservative. In some embodiments, layers with a preservative need not include a charge. In some embodiments, intervening layers can be placed between the various charged and/or preservative including layers noted herein.

In some embodiments, the packaging material includes at least one antibacterial layer. In some embodiments, one or more of the layers described herein is an antibacterial layer. In some embodiments, the antibacterial layer inhibits bacterial growth as described herein. In some embodiments, the layer can be antibacterial by the presence of one or more preservatives.

In some embodiments, for any two consecutive layers, the charge of one layer includes an anion, and the charge of the other layer includes a cation. Accordingly, the packing material can include alternating positively- and negatively-charged layers. In some embodiments, one of the first charge and the second charge includes an anion and the other of the first charge and the second charge comprises a cation. In some embodiments, the charged surface includes a cation. In some embodiments, the charged surface includes an anion. In some embodiments, any one of the layers as described herein includes an anion. In some embodiments, any one of the layers as described herein includes a cation.

In some embodiments, the preservative of any of the layers described herein includes a biological preservative. In some embodiments, the biological preservative has antibacterial properties. In some embodiments, the preservative includes a charge. In some embodiments, the biological preservative includes a cation. In some embodiments, the biological preservative includes a polycation. In some embodiments, the biological preservative includes one or more of the following cations: a chitosan, a collagen, a polylysine, or a nisin. In some embodiments, the biological preservative includes an anion. In some embodiments, the biological preservative includes a polyanion. In some embodiments, the anion includes at least one of the following anions: dextran sulfate, sodium alginate, pectin, heparin, heparin sulfate, or chondroitin sulfate. In some embodiments, the first preservative includes a biological preservative, for example, at least one of a polycation, a chitosan, a collagen, a polylysine, a nisin, dextran sulfate, sodium alginate, pectin, heparin, heparin sulfate, a polyanion or chondroitin sulfate.

In some embodiments, a preservative described herein can include a charge. In some embodiments, the preservative molecule is a molecule of a preservative. In some embodiments, the charge is covalently linked to the preservative molecule. For example, the first preservative can include the first charge covalently linked to a preservative molecule. Thus, preservatives that are natively uncharged, can be associated with a charged moiety and thereby employed. In some embodiments, the preservative molecule is charged with the charge. For example, the first preservative can include a first preservative molecule that is a charged molecule, and thus, no charged moiety need be added to the molecule. In some embodiments, the charge includes an anion or cation as described herein.

In some embodiments, the initial charged surface is part of the substrate. In some embodiments, the charged surface is the surface of a substrate. In some embodiments, the substrate includes at least one of polyethylene, low-density polyethylene (LDPE), high-density polyethylene (HDPE), polyethylene terephthalate (PET), or polypropylene. In some embodiments, the substrate itself is charged. In some embodiments, the substrate is covalently linked to one or more charged molecules. The charged molecules can include any of the anions, cations, or charges described herein.

In some embodiments, the packaging material includes and/or is and/or is applied as a spray coating. In some embodiments, the spray coating is applied directly to a product to be packaged. In some embodiments, the spray coating is applied over one or more layers surrounding a product to be packaged. In some embodiments, a packaging material includes a first layer that includes a first charge. The first layer can include a first preservative as described herein. In some embodiments, the first layer includes a spray coating. In some embodiments, a packaging material includes a second layer that includes a second charge that is electrostatically attracted to the first charge. The second layer can include a second preservative as described herein. In some embodiments, the second layer includes a spray coating. In some embodiments, the packaging material includes at least one additional spray coating layer, for example at least about 1, 2, 3, 4, 5, 6, 7, 8, 9, 10, 20, 30, 40, 50, 60, 70, 80, 90, or 100 additional layers, including any range between any two of the preceding values and any range above any one of the preceding values. In some embodiments, the packaging material includes at least one spray-coating layer, and at least one non-spray-coating layer. Thus, in some embodiments, the material need not include a substrate or a charged substrate. In some embodiments, the alternating layers can be supplied in a kit that includes a solution for application that includes a positively charged preservative and/or a positively charged moieties in the solution, that result in a charged layer once at least partially dried. The kit can also include a solution for application that includes a negatively charged preservative and/or negatively charged moieties in the solution, that result in a charged layer once at least partially dried. In some embodiments, the preservative can be mixed with a charged polymer. The charged polymer can provide the electrostatic interaction between the layers, and the polymer aspect can help trap the preservative within the layers. In some embodiments, a barrier layer can then be sprayed and/or applied over the charged layers. The barrier layer need not have a preservative and/or any charge; however, it can include both if desired.

Some embodiments provided herein include a composite film. The composite film can include one or more pairs of alternating layers. The alternating layers can include a first layer. In some embodiments, the first layer includes a self-assembled structure. The alternating layers can include a second layer. In some embodiments, the second layer includes a self-assembled structure. In some embodiments, the first layer is associated with the second layer via an electrostatic attraction as described herein. In some embodiments, the composite film also includes a substrate. In some embodiments, at least one of the first layer or the second layer is associated with the substrate via an electrostatic attraction as described herein. In some embodiments, at least one layer of the composite film includes a preservative as described herein. In some embodiments, the composite film includes one or more additional layers. Each additional layer can be a layer as described herein.

Some embodiments provided herein include a packaging material. The packaging material can include a first layer. The first layer can include a first preservative. In some embodiments, the first preservative includes a first charge. The packaging material can include a second layer over the first layer. In some embodiments, the second layer includes a second preservative. In some embodiments, the second preservative comprises a second charge that is electrostatically attracted to the first charge. In some embodiments, one or more of the first preservative and second preservative can be as described herein.

Some embodiments provided herein include a product disposed within a packaging material. In some embodiments, the product is at least one of a food item, a beverage, a cosmetic item, or a medication. In some embodiments, the food item is perishable within a one year period, for example, the item will perish if left exposed for 12, 11, 10, 9, 8, 7, 6, 5, 4, 3, 2, or 1 month or more. In some embodiments, there is a substrate positioned between the layer and the product. In some embodiments, the first layer can be immediately adjacent to the product. In some embodiments, there is an intervening layer between the product and the first, charged, layer.

In some embodiments, the packaging materials as provided herein can be part of at least one of a film, a box, a bag, a pouch, a tray, a canister, a vial, or a carton. In some embodiments, the packaging material forms a least one container as described herein, which has a volume of at least about 0.01 liters, for example at least about 0.01, 0.1, 0.2, 0.3, 0.4, 0.5, 0.6, 0.7, 0.9, 1, 2, 3, 4, 5, 6, 7, 8, 9, 10, 20, 30, 40, 50, 100, or 1,000 liters or more, including any range between any two of the preceding values, and any range above any one of the preceding values.

Some embodiments provided herein relate to a method of storing a perishable product. The method can include providing a packaging material. The packaging material can include a charged surface that is electrostatically attracted to a first layer. In some embodiments, the first layer includes a biological preservative. The method can include placing a perishable product at least partially within the packaging material.

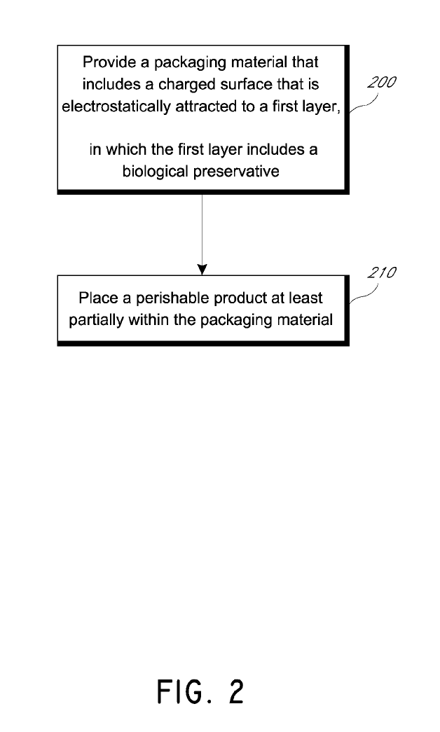

FIG. 2 is a flow diagram illustrating a method of storing a perishable product. The method can include providing a packaging material that includes a charged surface that is electrostatically attracted to a first layer, in which the first layer includes a biological preservative 200. The method can include placing a perishable product at least partially within the packaging material 210.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In some embodiments, any of the layers and any of the biological preservatives described herein can be used in the method. For example, the packaging material can further include a second layer, in which the second layer includes a second biological preservative, and in which the second biological preservative includes a second charge that electrostatically attracts the first charge.

In some embodiments, the method can include any of the charged surfaces and any of the substrates described herein can be used in the method. For example, the charged surface can be part of a substrate. The substrate can include at least one of polyethylene, low-density polyethylene (LDPE), high-density polyethylene (HDPE), polyethylene terephthalate (PET), or polypropylene. As noted herein, the method need not employ a substrate (for example, when layers are sprayed onto a product). In some embodiments, any of the first and/or second preservatives can be used within the first and/or second and/or subsequent layers.

In some embodiments, the method includes placing a perishable product at least partially within the packaging material. In some embodiments, at least about 20% of the perishable product is within the packaging material, for example at least about 20%, 30%, 40%, 50%, 60%, 70%, 80%, 90%, 91%, 92%, 93%, 94%, 95%, 96%, 97%, 98%, 99%, or 99.9% or all of the product, including any ranges between any two of the preceding values, and any range above any one of the preceding values can be within the packaging material. In some embodiments, the entire perishable product is placed within the packaged material. In some embodiments, the perishable product is placed within a substantially airtight configuration of the packaging material (such as a thermos, a balloon, a bag, etc.). In some embodiments, the substantially airtight configuration is impermeable to oxygen. In some embodiments, the substantially airtight configuration has an oxygen transmission rate of no more than about 50ml/m² day, for example no more than about 50ml/m² day, 40, 30, 20, 10, 9, 8, 7, 6, 5, 4, 3, 2, 1, 0.9, 0.8, 0.7, 0.6, 0.5, 0.4, 0.3, 0.2, 0.1, 0.01, 0.001 ml/m² day, or less, including any range between any two of the preceding values and any range below any one of the preceding values.

In some embodiments, the method includes storing a perishable product in the packaging material. In some embodiments, the product is stored for at least about 1 day, for example at least about 1 day, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, 100, 200, 300, 400, or 500 days, including any range between any two of the preceding values and any range above any one of the preceding values. Storing the perishable product can result in an increased shelf life of the product. In some embodiments, the shelf life of the product is at least about 1% longer than if the perishable product was placed in a packaging material that does not comprise the biological preservative, for example at least about 1%, 10%, 20%, 30%, 40%, 50%, 60%, 70%, 80%, 90%, 100%, 150%, 200%, 250%, 300%, 350%, 400%, 450%, 500%, 550%, 600%, 650%, 700%, 750%, 800%, 850%, 900%, 950%, or 1000% longer, including any range between any two of the preceding values and any range above any one of the preceding values. In some embodiments, the shelf life of the product is at least about 1 day longer than if the perishable product was placed in a packaging material lacking the biological preservative, for example at least about 1 day, 2, 3, 4, 5, 6, 7, 8, 9, 10, 20, 30, 40, 50, 60, 70, 80, 90, 100, 200, 300, 400, or 500 days longer, including any range between any two of the preceding values and any range above any one of the preceding values. In some embodiments, the shelf life of the product is measured based on typical storage conditions for the product. For example, the shelf life of a fruit or vegetable may be determined for ambient conditions of temperature, pressure, humidity, and the like. In some embodiments, the shelf life of the packaged product is measured in comparison to a reference product that is substantially the same as the packaged product. In some embodiments, the reference product is placed in a substantially airtight packaging that does not include a biological preservative. In some embodiments, the reference product is not placed in any packaging. In some embodiments, a log phase growth rate of a bacterial culture within the packaging material is less than a log phase growth rate of a comparable bacterial culture outside of the packaging material. In some embodiments, the log phase growth rate of the bacterial culture within the packaging material is less than about 80% of a log phase growth rate of a comparable bacterial culture outside of the packaging material, for example less than about 80%, 70%, 60%, 50%, 40%, 30%, 20%, 10%, 9%, 8%, 7%, 6%, 5%, 4%, 3%, 2%, 1%, 0.1%, or 0.01% of the log phase growth rate, including any range between any two of the preceding values and any range below any one of the preceding values. In some embodiments, each bacterial culture includes one or more of Escherichia coli, Staphylococcus aureus, Pseudomonas aeruginosa, or Enterococcus faecalis. In some embodiment, each bacterial culture is cultured in standard LB media at 37° C. In some embodiments, the perishable product includes any of the perishable products described herein, for example, a pharmaceutical product, a fruit, a vegetable, a dairy product, or a meat product.

In some embodiments, the material has a preservative effect on at least one type of bacteria. In some embodiments, the material provides an antibacterial benefit against at least one or more of Escherichia coli, Staphylococcus aureus, Pseudomonas aeruginosa, or Enterococcus faecalis.

Some embodiments provided herein relate to a method of making a packaging material. In some embodiments, the method includes providing a substrate. In some embodiments, a surface of the substrate includes a first charge. The method can include applying a first preservation material to the surface of the substrate. In some embodiments, the first preservation material includes a second charge that is electrostatically attracted to the first charge, thereby forming a first layer of charged preservation material at least over at least a part of the surface. In some embodiments, the substrate can be any substrate described herein. In some embodiments, each of the first charge and second charge can be any pair of charges that are electrostatically attracted to each other. In some embodiments, the first preservation material can include any preservative as described herein, or a precursor thereof. In some embodiments, the first layer is as described herein. In some embodiments, a second layer, having a second preservation material can then be applied over at least a part of the first layer. The second layer (and/or the second preservation material itself) can include a charge that will be attracted to the charge in the first layer, thereby allowing for a layered charge based arrangement. In some embodiments, additional interactions between the layers (such as hydrophobic interactions, etc.) can also attribute to the layers staying together.

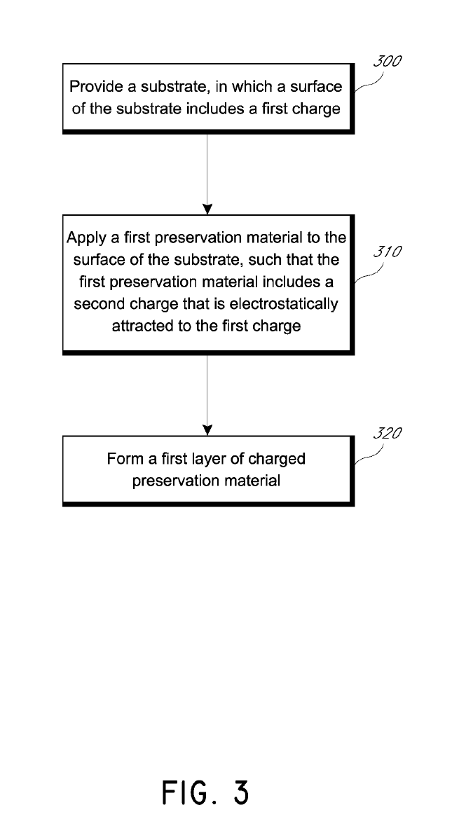

FIG. 3 is a flow diagram illustrating some embodiments of a method of making a packaging material. The method can include providing a substrate, in which a surface of the substrate includes a first charge 300. The method can include applying a first preservation material to the surface of the substrate, such that the first preservation material includes a second charge that is electrostatically attracted to the first charge 310. The method can thus include forming a first layer of charged preservation material 320.

FIG. 1 includes a schematic illustration of some embodiments of a method of making a packaging material 100. In some embodiments, a charged surface 110 is contacted by a polyanion and washed, thus forming a first layer 120 over the charged surface, in which the first layer includes a charge 126. The charged surface 110 and first layer 120 can be contacted by a polycation and washed, thus forming a second layer 130 overlaying the first layer 120, in which the second layer includes a charge 136. The charge 136 of the second layer 130 can be electrostatically attracted to the charge 126 of the first layer 120. In some embodiments, the packaging material can be created by a layer by layer application process.

As noted above, in some embodiments, the method also includes applying a second preservation material to a surface of the first layer of charged preservation material. In some embodiments, the second preservation material includes a third charge that is electrostatically attracted to the second charge, thus forming a second layer of charged preservation material that is electrostatically attracted to the first layer. In some embodiments, the third charge can be the same (for example, can be positive or negative) as the first charge. In some embodiments, the preservation material can include any preservative described herein, or a precursor thereof. In some embodiments, the first and second layer can be layers as described herein. In some embodiments, the second and third charges include a pair of electrostatically attracted charges as described herein.

In some embodiments, applying a preservation material as described herein includes at least one of spraying or spreading a surface with, or immersing a surface in a solution containing a preservation material. In some embodiments, a layer of preservation material is sprayed directly on the product to be packaged (and thus, the surface can be a surface of a product, which can, but need not, be charged). In some embodiments, a layer of preservation material is sprayed over one or more layers covering a product to be packaged. In some embodiments, at least one layer is a self-assembling layer. In some embodiments, self-assembly results from electrostatic attraction between a surface (for example a substrate or underlying layer) and a preservation material or precursor thereof. In some embodiments, the electrostatic interaction is as described herein.

In some embodiments, the method includes repeating the applying of any of the preservation materials as described herein. For example, the method can include repeating the applying the first preservation material to a surface of the second layer to form a third layer. For example, the method can include repeatedly applying the second preservation material to a surface of the third layer to form a fourth layer. For example, the method can include repeatedly the applying the first and the second preservation materials to form further layers of charged preservation material. In some embodiments, the method includes at least one iteration of the preceding repetitions, for example at least 1, 2, 3, 4, 5, 6, 7, 8, 9, 10, 20, 30, 40, 50, 60, 70, 80, 90, or 100 iterations, including any range between any two of the preceding values and any range above any one of the preceding values. In some embodiments, different preservatives can be used, so that a variety of bacteria can be slowed or inhibited. In some embodiments, a variety of different, but similarly charged, preservatives can be used within a single layer. Thus, 2, 3, 4, 5, 10, 15, 20 or more different positively charged preservatives can be used within a single layer. Similarly, 2, 3, 4, 5, 10, 15, 20 or more different negatively charged preservatives can be used within a single layer. In some embodiments, through an entire thickness of a preservative material, the layers can alternate, such that the positively charged preservatives are the same throughout, and the negatively charged preservatives are the same throughout. In embodiments in which the preservatives are modified to include a positive or negative charge, the preservatives can be the same throughout adjacent layers. Similarly, in embodiments in which other polymers are used to trap the preservatives within a layer, the preservatives can also be the same in adjacent layers.

In some embodiments, the method includes providing a substrate with a charge on a surface of the substrate. This can include contacting a substrate with a solution. The solution can include a polyamine and/or an organic solvent. In some embodiments, the polyamine includes at least one of ethylenediamine, propanediamine, di-n-octylamine, polyethyleneimine, polyallylamine, or polydimethyldiallylammoniumcholoride. In some embodiments, the organic solvent includes at least one of ethanol, propanol, isopropanol, glycoldimethylether, or dimethylsulfoxide.

Traditional preservative films include polyethylene, polyester, etc. These films can be associated with a short shelf life for some packaged products. Commercial polyvinyl chloride films can contain carcinogenic substances, which can be harmful to human health. In some embodiments, the various layers provided herein can be applied over and/or in addition to these traditional films.

Some embodiments provide a low cost and/or safe packaging materials. In some embodiments, in order to improve food safety and shelf life, some biodegradable and antibacterial materials (chitosan, collagen, nisin, etc.) are coated onto film materials (polyethylene, poly(ethylene terephthalate) (PET), polypropylene, etc.) by the layer-by-layer (LBL) deposition nanotechnology. In some embodiments, the shelf life of food packaged inside such films is at least two times higher than that of comparable food packaged inside traditional films, for example, 2, 3, 4, 5, 6, 7, 8, 9, 10 or more times longer, including any range between any two of these values.

In some embodiments, films described herein, for example LBL films, have good chemical stability, composition and thickness controllability. In some embodiments, the thickness can is controlled at the nanometer level. In some embodiments, the film can be from 1 nanometer to 10 cm in thickness.

In some embodiments, the processing of adding antibacterial agents is simple, low energy consumption and low cost.

In some embodiments, in comparison with existing antibacterial plastic wrap, the antibacterial agents are distributed more uniformly, and thus have better antibacterial effects than existing antibacterial plastic wrap.

In some embodiments, multilayer films can inhibit and/or slow the ripening of vegetables and fruits. In some embodiments, multilayer films have high antimicrobial activity.

### EXAMPLES 1-8

### Preparation of Films

Polyamine solutions with a concentration of 0.05-1.5 g/mL are prepared by dissolving the polyamine in an organic solvent with vigorous stirring. The polyamine includes at least one of ethylenediamine, propanediamine, di-n-octylamine, polyethyleneimine, polyallylamine, or polydimethyldiallylammoniumchloride. The organic solvent includes at least one of ethanol, propanol, isopropanol, glycoldimethylether and dimethylsulfoxide. The polyamine and organic solvent combinations of Examples 1-8 are shown in Table 1.

A film material is then immersed in the polyamine solution and reacted for 1 hour to 10 hours at a temperature below 25° C., as shown in Table 1. The film material is at least one of polyethylene, low-density polyethylene, high-density polyethylene, PET and polypropylene. The specific film material combinations with the specific polyamine and organic solvents are specified in Table 1.

The film is then removed from the polyamine solution and washed 4 to 6 times with deionized water. The films are kept at 25 ° C. to constant weight in vacuum.

The film is then immersed in a 0.002 M to 0.1 M acid solution.

The positively charged film is then immersed in a biologically active polyanion solution (at a concentration of 5 to 25 mg/mL), resulting in a negatively charged surface. The materials are then removed from the polyanion solution, and washed 4-6 times with deionized water. The polyanion solution includes at least one of dextran sulfate, sodium alginate, pectin, heparin, heparan sulfate and chondroitin sulfate. The specific polyanion solution, film, polyamine, and organic solvent of Examples 1-8 are specified in Table 1.

This film is immersed in a polycation solution with preservation and antibacterial function (at a concentration of 5 to 25 mg/mL) so that a cation layer is adsorbed. The polycation solution includes one or more of chitosan, collagen, polylysine and nisin. The specific polycation solution, polyanion solution, film, polyamine, and organic solvent of Examples 1-8 are specified in Table 1.

The film is washed 4 to 6 times with deionized water, resulting in a positively charged surface.

The polyanion solution dip and the polycation solution dip and wash are repeated 3 times. This provides a multilayer film with preservation and antibacterial functionality.

TABLE 1

| | | Organic | Film | Polyanion | Polycation |
|---|---|---|---|---|---|
| Example | Polyamine | Solvent | Material | Solution | Solution |
| 1 | ethylene-diamine | ethanol | polyethylene | dextran | chitosan |
| | | | | sulfate | |
| 2 | propane-diamine | ethanol and | low-density | heparin | collagen |
| | | isopropanol | polyethylene | | |
| 3 | Polyethylene- | propanol | high-density | pectin | polylysine |
| | imine and | | polyethylene | | and collagen |
| | polyallylamine | | | | |
| 4 | ethylenediamine | isopropanol | PET | heparin | polylysine |
| | and di-n- | | | | |
| | octylamine | | | | |
| 5 | polyallylamine | ethanol | polypropylene | heparan | chitosan and |
| | | | | sulfate | polylysine |
| 6 | polyethylene- | Dimethyl- | polyethylene | chondroitin | polylysine |
| | imine | sulfoxide | and | sulfate | |
| | | | polypropylene | | |
| 7 | polydimethyl- | isopropanol | polyethylene | sodium | nisin |
| | diallyl-ammonium | | and PET | alginate | |
| | chloride | | | | |
| 8 | propane-diamine | Dimethyl- | polyethylene | heparin | chitosan |
| | | sulfoxide | | | |

### EXAMPLE 9

### Production and Use of a Layered Film

Ethylenediamine solutions with a concentration of 0.05 g/mL were prepared by dissolving ethylenediamine in ethanol with vigorous stirring. A polyethylene film was immersed in the ethylenediamine solution for 1 hour at a temperature below 25° C. The film was removed from the ethylenediamine solution and washed 4 times with deionized water. The film was dried at 25° C. to a constant weight in a vacuum.

The polyethylene film was immersed in a 0.002 M acid solution for 1 hour. Then, it was removed and washed 4 times resulting in a positively charged surface. The positively charged polyethylene film was immersed in 5 mg/mL sodium alginate solution. The film adsorbed an anion layer and thus had a negatively-charged surface. The film was removed from the sodium alginate solution, and washed 4 times with deionized water. Then, the film was immersed in 5 mg/mL chitosan solution, where it adsorbed a cation layer. It was washed 4 times with deionized water resulting in a positively-charged surface. The sodium alginate and chitosan dips and washes were repeated one time to produce a multilayer film.

According to a FZ/T01021 antibacterial test, the antibacterial rate of the produced multilayer films was beyond 90% for Escherichia coli. The shelf life for the multilayer food package films was two times higher than that of an untreated polyethylene film.

### EXAMPLE 10

### Production and Use of a Layered Film

A polyallylamine solution at a concentration of 1 g/mL was prepared by dissolving polyallylamine in propanol with vigorous stirring. A PET film was immersed in the polyallylamine solution and reacted for 5 hours at a temperature beneath 25 ° C. Then, the film was removed and washed 4 times with deionized water. This film was dried at 25° C. to a constant weight in a vacuum.

The aminated PET film was immersed in a 0.05 M acid solution for 1 hour. It was removed and washed 4 times resulting in a positively charged surface. The positively charged PET film was immersed in 10 mg/mL dextran sulfate solution to adsorb an anion layer to it, and thus become a negatively charged surface. It was removed and washed 5 times with deionized water. The film was immersed in 10 mg/mL nisin solution to adsorb a cation layer. The film was washed five times with deionized water. The film thereby had a positively charged surface. The dextran sulfate and nisin dipping and washing processes were repeated two times to produce the multilayer film.

According to a FZ/T01021 antibacterial test, the antibacterial rate of the multilayer films was beyond 90% for Escherichia coli. The shelf life for the multilayer food package films was three times higher than that of an untreated PET film.

### EXAMPLE 11

### Production and Use of a Layered Film

A polyethyleneimine solution with a concentration of 1 g/mL was prepared by dissolving polyethyleneimine in isopropanol with vigorous stirring. A polypropylene film was immersed in the polyethyleneimine solution and reacted for 10 hours at a temperature beneath 25 ° C. The film was removed and washed 4 times with deionized water. This film was dried at 25 ° C. until at a constant weight, under a vacuum.

The polypropylene film was immersed in a 0.1 M acid solution for 1 hour. The film was removed and washed 4 times resulting in a positively charged surface. The positively charged polypropylene film was immersed in 10 mg/mL chondroitin sulfate solution, which adsorbed an anions layer to the film, providing the film with a negatively charged surface. The film was removed and washed 6 times with deionized water. The film was immersed in 10 mg/mL chitosan/nisin (l/l, w/w) solution. This adsorbed a cation layer to the film, which was then washed six times with deionized water. A positively charged surface was thereby prepared. The formation of the negatively and positively charged surface was repeated two times to form a multilayer film.

According to a FZ/T01021 antibacterial test, the antibacterial rate of the multilayer films was beyond 95% for Escherichia coli. The shelf life for the multilayer food package film was four times higher than that of an untreated PP film.

### EXAMPLE 12

### Use of a Multilayer Film

The film of Example 10 is wrapped around 2 liters of fruit and sealed in a substantially airtight manner, thus packaging the fruit. The fruit is stored for 5 days. The shelf life of the fruit is greater than if the fruit had not been wrapped in any packaging.

### EXAMPLE 13

### Use of a Multilayer Film

A 5-liter pouch made out of the film of Example 11 is filled with a pharmaceutical product. The pouch is sealed in a substantially airtight manner. The product is stored at 10° C. for 100 days. The shelf life of the pharmaceuticals is extended (as compared to a similar pouch made of low-density polyethylene, but without an antibacterial layer) by being in the pouch of the film of Example 11.

### EXAMPLE 14

### Comparison of Effectiveness of Various Films

A film of PET is compared next to a film of layered PET (as provided in Example 10) for its ability to be effective against three pathogens over a 14 day storage period. The results are shown in Table 2.

TABLE 2

| | Film--PET-Chitosan, (per | | | |
|---|---|---|---|---|
| | (Dutta P, Tripathi S, Mehrotra | | | |
| | G and Dutta J. Perspectives for | | | |
| | Chitosan Based Antimicrobial | | | |
| | Films in Food Applications[J]. | | | |
| | Food Chemistry, 2009, 114(4): | | | |
| | 1173-1182.)) | | Film (Layered PET) | |
| | Initial | After | Initial | After |
| | inoculation | 14 days | inoculation | 14 days |
| | level | storage | level | storage |
| | (log | (log | (log | (log |
| Pathogen | CFU/g) | CFU/g) | CFU/g) | CFU/g) |
| L. | 5.11 | 4.02 | 5.24 | 3.80 |
| monocytogenes | | | | |
| S. aureus | 4.92 | 3.31 | 5.10 | 3.01 |
| E. coli O | 4.88 | 3.29 | 5.01 | 2.95 |
| I57:H7 | | | | |

As can be seen by the results in table 2, the present embodiments not only provide a decrease in pathogen level after two weeks, but the decrease was greater than that seen with other films.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases one or more or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A packaging material comprising:
a substrate having a charged surface; and
a first layer over the charged surface, wherein the first layer comprises a first preservative, and wherein the first preservative comprises a first charge that is electrostatically attracted to the charged surface, wherein the packaging material is configured to allow the first preservative to function as a preservative for a perishable product.

2. The packaging material of claim 1, further comprising at least one antibacterial layer.

3. The packaging material of claim 1, further comprising a second layer over the first layer, wherein the second layer comprises a second preservative, wherein the second preservative comprises a second charge that is electrostatically attracted to the first charge.

4. The packaging material of claim 3, wherein one of the first charge and the second charge comprises an anion and the other of the first charge and the second charge comprises a cation.

5. The packaging material of claim 4, wherein the anion comprises at least one of dextran sulfate, sodium alginate, pectin, heparin, heparin sulfate, or chondroitin sulfate.

6. The packaging material of claim 4, further comprising a third layer over the second layer, wherein the third layer comprises a third charge that is electrostatically attracted to the second charge.

7. The packaging material of claim 6, further comprising a fourth layer over the third layer, wherein the fourth layer comprises a fourth charge that is electrostatically attracted to the third charge.

8. The packaging material of claim 1, wherein the first preservative comprises a biological preservative.

9. The packaging material of claim 1, wherein the first preservative comprises at least one of a polycation, a chitosan, a collagen, a polylysine, or a nisin.

10. The packaging material of claim 1, wherein the first preservative comprises the first charge covalently linked to a preservative molecule.

11. The packaging material of claim 1, wherein the first preservative comprises a first preservative molecule that is charged with the first charge.

12. The packaging material of claim 1, wherein the charged surface is part of a substrate.

13. The packaging material of claim 12, wherein the substrate comprises at least one of polyethylene, low-density polyethylene (LDPE), high-density polyethylene (HDPE), polyethylene terephthalate (PET), or polypropylene.

14. The packaging material of claim 1, wherein the charged surface is a surface of a substrate.

15. The packaging material of claim 1, wherein the packaging material is part of a film, a box, a bag, a pouch, a tray, a canister, a vial, or a carton.

16. A method of storing a perishable product, the method comprising:
providing a packaging material comprising a substrate, wherein the substrate has a charged surface, the packaging material further comprising a first layer, wherein the charged surface is electrostatically attracted to the first layer, wherein the first layer comprises a biological preservative, and wherein the biological preservative comprises a first charge; and
placing a perishable product at least partially within the packaging material,
wherein the packaging material is configured to allow the biological preservative to function as a preservative for the perishable product.

17. The method of claim 16 wherein the packaging material further comprises a second layer, wherein the second layer comprises a second biological preservative, and wherein the second biological preservative comprises a second charge configured to electrostatically attract the first charge.

18. The method of claim 16, wherein placing the perishable product comprises placing the product within a substantially airtight configuration of the packaging material.

19. The method of claim 16, wherein the charged surface is part of a substrate, the substrate comprising at least one of polyethylene, low-density polyethylene (LDPE), high-density polyethylene (HDPE), polyethylene terephthalate (PET), or polypropylene.

20. The method of claim 16, the method further comprising storing the perishable product in the film, thereby resulting in an increased shelf life of the perishable product.

21. The method of claim 16, wherein the perishable product is preserved at least about 40% longer than if the perishable product was placed in a packaging material that does not comprise the biological preservative.

22. The method of claim 16, wherein the perishable product comprises at least one of a pharmaceutical product, a fruit, a vegetable, a dairy product, or a meat product.

23. The method of claim 16, wherein a log phase growth rate of a bacterial culture within the packaging material is no more than about 20% of a log phase growth rate of a comparable bacterial culture outside of the packaging material.

24. A method of making a packaging material, the method comprising:
providing a substrate, wherein a surface of the substrate comprises a first charge; and
applying a first preservation material to the surface of the substrate, wherein the first preservation material comprises a second charge that is electrostatically attracted to the first charge, thereby forming a first layer of charged preservation material.

25. The method of claim 24, the method further comprising:
applying a second preservation material to a surface of the first layer of charged preservation material, wherein the second preservation material comprises a third charge that is electrostatically attracted to the second charge, thereby forming a second layer of charged preservation material.

26.-36. (canceled)
